(19) United States
(12) Patent Application Publication
(10) Pub. No.: US 2007/0081427 A1
(43) Pub. Date: Apr. 12, 2007

(54) Light delivery module and heat-assisted magnet recording head employing the same

(75) Inventors: Sung-dong Suh, Seoul (KR); Jin-seung Sohn, Seoul (KR); Byung-Kyu Lee, Seoul (KR); Eun-hyoung Cho, Seoul (KR)

Correspondence Address: SUGHRUE MION, PLLC, 2100 PENNSYLVANIA AVENUE, N.W., SUITE 800, WASHINGTON, DC, 20037, US

(73) Assignee: SAMSUNG ELECTRONICS CO., LTD.

(21) Appl. No.: 11/506,889

(22) Filed: Aug. 21, 2006

(30) Foreign Application Priority Data
Oct. 6, 2005 (KR) 10-2005-0093909

(51) Int. Cl. G11B 11/00

(52) U.S. Cl. 369/13.33

(57) ABSTRACT

A light delivery module having a structure in which components can be precisely aligned and be integrated as a single unit, and a heat-assisted magnetic recording (HAMR) head employing the light delivery module. The light delivery module includes: a base having a first groove; a light source mounted on the base; an optical device that is installed on the base and guides light radiated from the light source; a cover member that is bonded to the base to protect the light source and the optical device and has a second groove facing the first groove; and a nano aperture bonded in the first and second grooves to form an enhanced near-field by adjusting the distribution of the light transmitted through the optical device.

### CROSS-REFERENCE TO RELATED PATENT APPLICATIONS

This application claims priority from Korean Patent Application No. 10-2005-0093909, filed on Oct. 6, 2005, in the Korean Intellectual Property Office, the disclosure of which is incorporated herein in its entirety by reference.

### BACKGROUND OF THE INVENTION

1. Field of the Invention

The present invention relates to a light delivery module having a structure with which an enhanced near-field can be realized and a heat-assisted magnetic recording (HAMR) head employing the same and, more particularly, to a light delivery module with components which can be precisely aligned and a HAMR head employing the light delivery module.

2. Description of the Related Art

Since light is produced with a resolution beyond a diffraction limit in various fields of technology, techniques for realizing an enhanced near-field is being studied.

Specifically, research into the increase of recording density by magnetic recording heads has been performed. Since a recording bit becomes thermally unstable in a magnetic recording method, in which only a magnetic field is used to record data, it is difficult to increase recording density. To overcome this, a heat-assisted magnetic recording (HAMR) head including a light delivery module that radiates light to heat the magnetic recording medium locally and thus temporarily reduce the coercive force of the magnetic recording medium to facilitate recording has been disclosed.

Referring to FIG. 1, a conventional HAMR head 10 includes a magnetic recording unit 20 and a light delivery module 30 for heating a magnetic recording medium 40.

The magnetic recording unit 20 includes a recording pole 21 for applying a magnetic field to the magnetic recording medium 40 and a return pole 25 magnetically connected to the recording pole 21 by a yoke 23 to complete a magnetic path M.

The light delivery module 30 heats a predetermined portion A of the magnetic recording medium 40 by near-field illumination and includes a light source 31 and a light wave guide 35 for guiding the light radiated from the light source 31. The light source 31 is coupled with the light wave guide 35 through an optical fiber 33 for transferring light and an integrated spherical lens 34 for collimating the light emitted from the optical fiber 33.

The magnetic recording medium 40 moves in a direction D with respect to the HAMR head 10. The heated portion A is placed in front of the recording pole 21 due to the relative motion of the magnetic recording medium 40. Accordingly, since the recording pole 21 magnetically records to the heated portion A vertically, thermal instability in magnetic recording is overcome.

Since the light wave guide 35 is attached outside of the recording pole 21, when the magnetic recording unit 20 is moved upward from the magnetic recording medium 40 by an air bearing system, a predetermined distance can be maintained between the light wave guide 35 and the magnetic recording medium 40.

Precise polarization alignment between a nano aperture 37 improving light intensity for high density recording and the light wave guide 35 is required. Moreover, since the structure, in which only the light wave guide 35 and the nano aperture 37 are combined with the magnetic recording unit 20 and the light source 31 and the optical fiber 33 are installed in an additional structure (not shown), is complicated, the number of assembling processes and manufacturing costs increase.

### SUMMARY OF THE INVENTION

The present invention provides a light delivery module having a structure in which components can be precisely aligned and be integrated as a single unit, and a heat-assisted magnetic recording (HAMR) head employing the light delivery module.

According to an aspect of the present invention, there is provided a light delivery module comprising: a base having a first groove; a light source mounted on the base; an optical device that is installed on the base and guides light outputted from the light source; a cover member that is bonded to the base to protect the light source and the optical device and has a second groove facing the first groove; and a nano aperture bonded in the first and second grooves to form an enhanced near-field by adjusting the distribution of the light transmitted through the optical device.

According to an aspect of the present invention, there is provided a heat-assisted magnetic recording (HAMR) head comprising a magnetic recording unit which comprises: a recording pole which applies a magnetic recording field; and a return pole magnetically connected to the recording pole to complete a magnetic path; and a light delivery module which comprises: a base having a first groove; a light source mounted on the base; an optical device that is installed on the base and guides light outputted from the light source; a cover member that is bonded to the base to protect the light source and the optical device and has a second groove facing the first groove; and a nano aperture bonded in the first and second grooves to form an enhanced near-field by adjusting the distribution of the light transmitted through the optical device.

### BRIEF DESCRIPTION OF THE DRAWINGS

The above and other features and advantages of the present invention will become more apparent by describing in detail exemplary embodiments thereof with reference to the attached drawings, in which:

FIG. 1 is a schematic view of a conventional heat-assisted magnetic recording (HAMR) head;

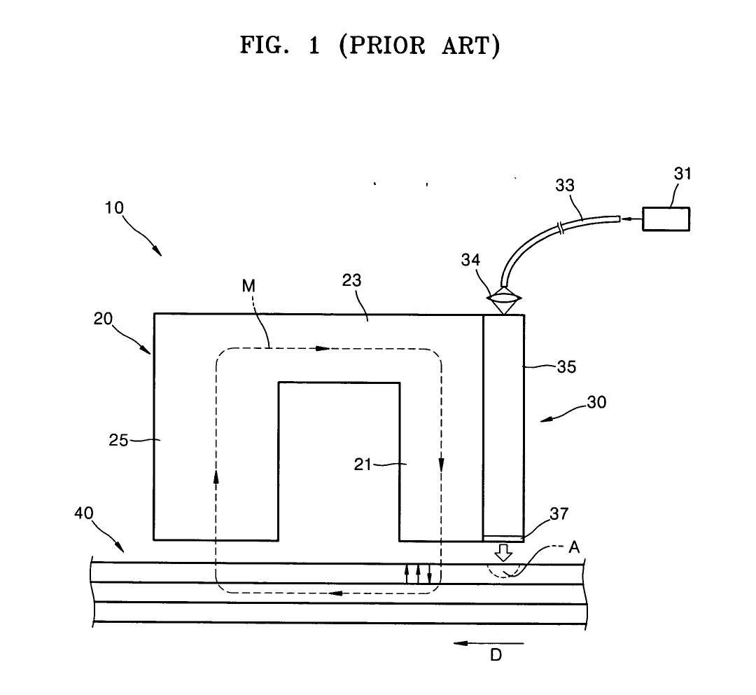

FIG. 2 is a cross-sectional view of a light delivery module according to an exemplary embodiment of the present invention;

FIG. 3 is an exploded perspective view of the light delivery module of FIG. 2;

FIGS. 4A through 4C illustrates a nano aperture of the light delivery module of FIG. 2 according to various exemplary embodiments of the present invention; and

FIG. 5 is a schematic view of a heat-assisted magnetic recording (HAMR) head according to an exemplary embodiment of the present invention.

### DETAILED DESCRIPTION OF THE INVENTION

The present invention will now be described more fully with reference to the accompanying drawings, in which exemplary embodiments of the invention are shown.

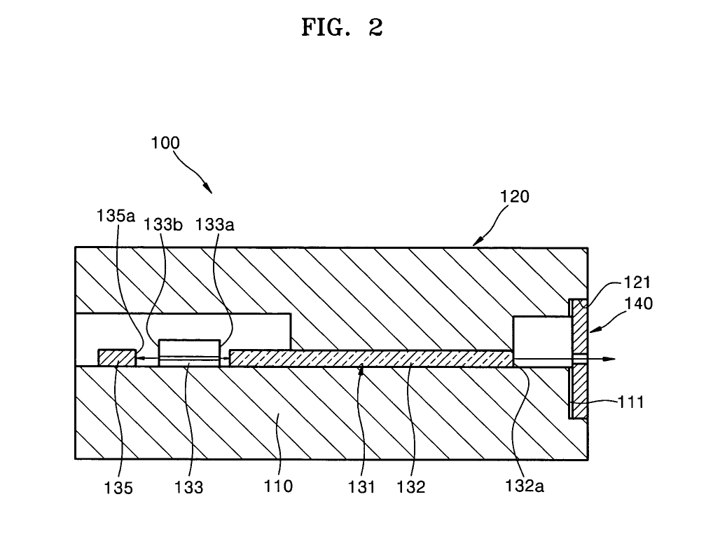

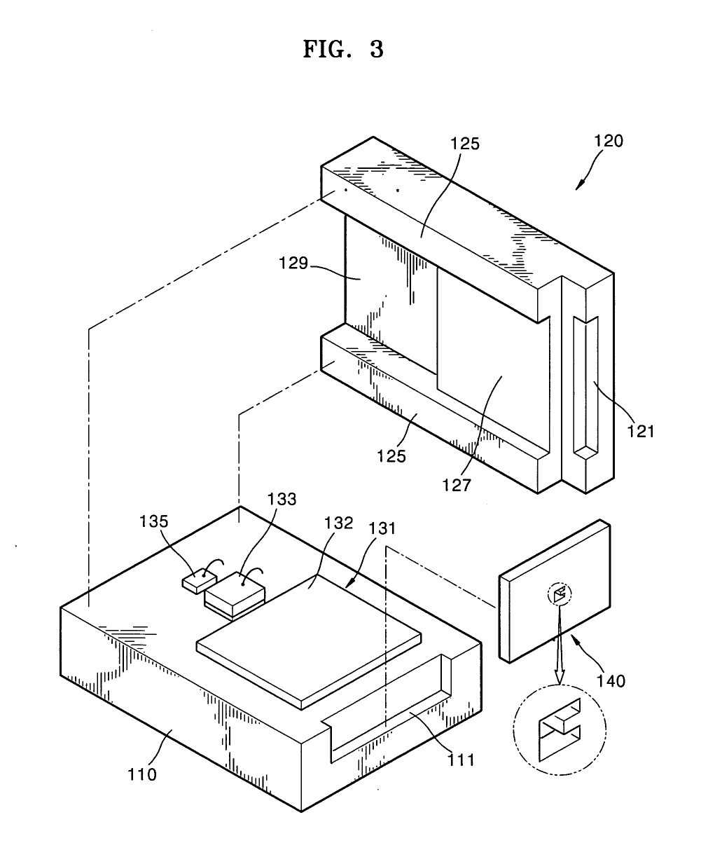

FIG. 2 is a cross-sectional view of a light delivery module 100 according to an exemplary embodiment of the present invention. FIG. 3 is an exploded perspective view of the light delivery module 100.

Referring to FIGS. 2 and 3, the light delivery module 100 includes a base 110, an optical device 131 for guiding light and a light source 133 installed on the base 110, a cover member 120 bonded to the base 110 to protect the light source 133 and the optical device 131, and a nano aperture 140 forming an enhanced near-field. The optical device 131 includes a light wave guide 132 or a lens such as a graded index (GRIN) lens or a rod. In the present embodiment, a light wave guide 132 is included, and the description of an embodiment employing a lens as an optical device 131 will be omitted.

The light delivery module 100 may further include a photodetector 135 receiving a portion of light emitted from the light source 133 to monitor the light output of the light source 133.

The base 110 is made of a material such as silicon, and has a first groove 111.

The light source 133 is mounted on the base 110 and radiates a beam with a predetermined wavelength. The light source 133 may be a laser diode radiating light with a predetermined polarization.

The light wave guide 132 is bonded to the base 110 and guides light radiated from the light source 133 toward the nano aperture 140. The light wave guide 132 guides the incident light by internal total reflection, and is made of a material having a relatively high refractive index compared to the base 110 and the cover member 120.

The light wave guide 132 is planar, as illustrated in FIG. 2, and intensifies polarization parallel to the width direction of a light emitting surface 132a of the light wave guide 132. The light wave guide 132 of the current embodiment is simple and does not include a nano aperture 140, and is thus easy to manufacture.

The cover member 120 is bonded to the top surface of the base 110 and protects the light source 133, the light wave guide 132, and the photodetector 135. Thus, pollution of the light emitting surfaces 133a and 133b of the light source 133 and the light receiving surface 135a of the photodetector 135 can be reduced. The cover member 120 has a second groove 121 facing the first groove 111.

Accordingly, precise polarization alignment between the light wave guide 132 and the nano aperture 140 can be achieved by installing the nano aperture 140 between the first and second grooves 111 and 121 considering the polarization of the incident light.

The cover member 120 further includes bonding bridges 125 connected to the base 110. The bonding bridges 125 protrude toward the base 110 and are disposed around the light source 133, the light wave guide 132, and the photodetector 135.

A first space 127 for accommodating the light wave guide 132 and a second space 129 for accommodating the light source 133 and the photodetector 135 are formed between the two bonding bridges 125. Accordingly, when the cover member 120 is bonded to the base 110, damage to the electric wiring of the light source 133 and the photodetector 135 is prevented.

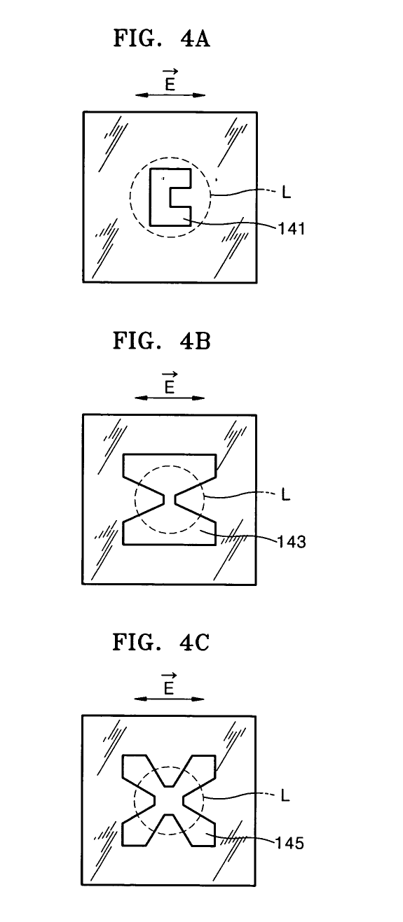

The nano aperture 140 is bonded in the first groove 111 and the second groove 121. The nano aperture 140 forms an enhanced near-field by the adjusting the distribution of light transmitted through the light wave guide 132. FIGS. 4A through 4C illustrate nano apertures of the light delivery module according to various exemplary embodiments of present invention.

FIG. 4A illustrates a nano aperture 141 with a “C” shape. Referring to FIGS. 3 and 4A, the light which is transmitted through the light wave guide 132 is polarized, that is, the electrical field \vec{E} is polarized parallel to the width direction of the light emitting surface 132a. As the C-shaped nano aperture 141 is disposed as illustrated in FIG. 4A, the electrical field is enhanced by electric dipole vibration in the narrow center of the nano aperture 141, and thus light energy in a wide area can be focused locally. Accordingly, light having partially enhanced light energy can be transmitted. L denotes the radius of a beam of the light incident on the nano aperture 141.

FIG. 4B illustrates a bow-tie shaped nano aperture 143. FIG. 4C illustrates an X-shaped nano aperture 145. In the apertures 143 and 145 of FIGS. 4B and 4C, the electrical field formed at the center point of the apertures 143 and 145 increases a great deal, and thus the light energy can be focused locally as in FIG. 4A.

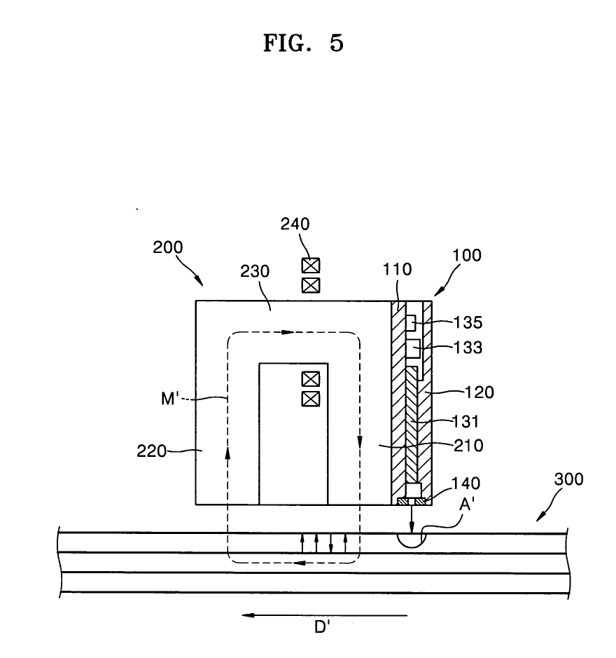

FIG. 5 is a schematic view of a heat-assisted magnetic recording (HAMR) head according to an exemplary embodiment of the present invention. Referring to FIG. 5, the HAMR head includes a magnetic recording unit 200 and a light delivery module 100 for heating a magnetic recording medium 300.

The magnetic recording unit 200 includes a recording pole 210 applying a magnetic recording field to the magnetic recording medium 300, a return pole 220 magnetically connected to the recording pole 210 by a yoke 230 to complete a magnetic path M, and a magnetized coil 240 wrapped around the yoke 230. The magnetic recording unit 200 may include a recording head (not shown). The recording head is well known in the art, and thus a description thereof will be omitted.

The light delivery module 100 heats a predetermined portion A′ of the magnetic recording medium 300 through near-field illumination, and is formed as a single unit. The light delivery module 100 includes a base 110 attached to the magnetic recording unit 200, and an optical device 131, a light source 133, a photodetector 135 for monitoring light output, a cover member 120, and a nano aperture 140 are connected to the base 110. The light delivery module 100 is the same as the light delivery module 100 in FIGS. 2 through 4C, and the description thereof will not be repeated.

The magnetic recording medium 300 moves in a direction D′ with respect to the HAMR head. The heated portion A′ moves below the recording pole 210 due to the relative motion of the magnetic recording medium 40. Accordingly, since the recording pole 210 magnetically records to the heated portion A′ vertically, thermal instability in magnetic recording is prevented.

Since the external surface of the base 110 is attached outside of the recording pole 210, when the magnetic recording unit 200 is moved upward from the magnetic recording medium 300 by an air bearing system, a predetermined distance can be maintained between the nano aperture 140 and the magnetic recording medium 300.

In the light delivery module according to the present invention, an optical device and a nano aperture are installed using a base and a cover member so that precise alignment between the optical device and the nano aperture can be achieved. Moreover, a nano aperture is not attached to an end of the optical device but manufactured separately, and thus the manufacturing process is easy. Also, since a light source and a photodetector for monitoring are installed in the inner space of the cover member, the pollution thereof can be reduced.

Furthermore, the structure of the HAMR head according to the present invention is simplified since the light delivery module is formed as a single unit and is attached to the magnetic recording unit, and thus the number of manufacturing processes and manufacturing costs are reduced.

While the present invention has been particularly shown and described with reference to exemplary embodiments thereof, it will be understood by those of ordinary skill in the art that various changes in form and details may be made therein without departing from the spirit and scope of the present invention as defined by the following claims.

What is claimed is:

1. A light delivery module comprising:
a base having a first groove;
a light source mounted on the base;
an optical device that is installed on the base and guides light outputted from the light source;
a cover member that is bonded to the base to protect the light source and the optical device and has a second groove facing the first groove; and
a nano aperture bonded in the first and second grooves to form an enhanced near-field by adjusting the distribution of the light transmitted through the optical device.

2. The light delivery module of claim 1, wherein the optical device comprises one of a light wave guide and a lens for guiding incident light.

3. The light delivery module of claim 1, further comprising a photodetector that is interposed between the base and the cover member and receives a portion of the light emitted from the light source to monitor a light output of the light source.

4. The light delivery module of claim 3, wherein the optical device comprises one of a light wave guide and a lens for guiding incident light.

5. The light delivery module of claim 3, wherein the cover member comprises bonding bridges that face the base and are disposed outside the light source, the optical device, and the photodetector.

6. The light delivery module of claim 5, wherein the optical device comprises one of a light wave guide and a lens for guiding incident light.

7. A heat-assisted magnetic recording (HAMR) head comprising:
a magnetic recording unit which comprises:
a recording pole which applies a magnetic recording field; and
a return pole magnetically connected to the recording pole to complete a magnetic path; and
a light delivery module which comprises:
a base having a first groove;
a light source mounted on the base;
an optical device that is installed on the base and guides light outputted from the light source;
a cover member that is bonded to the base to protect the light source and the optical device and has a second groove facing the first groove; and
a nano aperture bonded in the first and second grooves to form an enhanced near-field by adjusting the distribution of the light transmitted through the optical device.

8. The HAMR head of claim 7, wherein the optical device comprises one of a light wave guide and a lens for guiding incident light.

9. The HAMR head of claim 7, wherein the light delivery module is interposed between the base and the cover member and receives a portion of the light emitted from the light source to monitor the light output of the light source.

10. The HAMR head of claim 9, wherein the cover member further comprises bonding bridges that face the base and are disposed outside the light source, the optical device, and the photodetector.

11. The HAMR head of claim 7, wherein an external surface of the base is attached to the outside of the recording pole.

12. The HAMR head of claim 11, wherein the light delivery module further comprises a photodetector that is interposed between the base and the cover member and receives a portion of the light emitted from the light source to monitor the light output of the light source.

13. The HAMR head of claim 12, wherein the cover member further comprises bonding bridges that face the base and are disposed outside the light source, the optical device, and the photodetector.
